(19) United States
(12) Patent Application Publication
(10) Pub. No.: US 2009/0221201 A1
(43) Pub. Date: Sep. 3, 2009

(54) Nano-particle finish for mineral and carbon fibers and fabric

(76) Inventors: H. Landis Carter, Greer, SC (US); Shobha Murari, Greenville, SC (US)

Correspondence Address: MCNAIR LAW FIRM, P.A., P.O. BOX 447, GREENVILLE, SC, 29602-0447, US

(21) Appl. No.: 12/072,961

(22) Filed: Feb. 29, 2008

(51) Int. Cl. B32B 27/06; D06M 23/00; C08G 77/12

(52) U.S. Cl. 442/175; 528/31; 427/299

(57) ABSTRACT

A composition and process in which a silane coupling agent has nano-mineral particles grafted to the silane copolymer molecules in the coupling agent and such coupling agent is applied to a scoured fabric prior to the fabric being coated with a polymeric coating.

### CROSS REFERENCE TO RELATED APPLICATION

This application claims priority of Provisional Application Ser. No. 60/881,295, filed Mar. 30, 2007.

### FIELD OF THE INVENTION

This invention relates to a finish composition for fibers and fabric that are made from minerals or carbon. More particularly, the invention relates to a finish in which nano-particles are employed with the coupling agent of the finish to provide a three-dimensional network of the coupling agent on the fiber surface.

### BACKGROUND OF THE INVENTION

The importance of composite materials in the modern world can hardly be overstated. Composites in general can be thought of as a combination of two or more distinctly dissimilar components and include a wide range of products such as sandwich structures, laminates, reinforced polymers, concrete, and fiber reinforced components which achieve high-strength, stiffness, and durability that cannot be achieved alone by the individual components of the composite. Often, one of the components of such composites serves as the matrix in which particles or fibers of the other are uniformly dispersed like aggregate and concrete. Now, in recent years, a new class of materials known as nano-composites have attracted great interest and research. These nano-composites offer properties not obtainable in the foregoing mentioned conventional composites and allow the construction of tailor-made advanced composites.

The nano-composites are multi-phased materials containing two or more dissimilar components mixed on the nano-meter scale. Particles of this size approach the size of atoms being in the range of 100 to 1000 times the size of a typical atom. These nano-composites exhibit new and often improved mechanical, catalytic, electronic, magnetic, and optical properties that are not possessed by their macro composite or micro composite counterparts. The reason for these different properties is not yet totally understood. Further description of many known nano-composites and their structures can be found in an article “Polymer Nano Composite Approach To Advanced Materials” found in the Journal of Chemical Education, at Vol. 77, No. 9, September 2000. Accordingly, it is one of the general objects of the present invention to uniquely apply nano technology to composites that employ mineral and carbon fibers.

To bond inorganic materials such as mineral fibers or carbon fibers with organic materials, coupling agents are used and commonly used coupling agents for these materials are the silanes. These agents have the ability to form durable bonds between inorganic and organic materials and can bond dissimilar material where at least one of the members is siliceous or has surface chemistry with siliceous properties such as the silicates, aluminates, borates, and the like. The interfaces involving such materials are modified in order to incorporate the flow properties of the material forming the composite structure. Thus, the use of the silane or organosilane coupling agents on mineral surfaces such as fiberglass will bond a polymeric surface such an epoxy or fluorocarbon to the glass surface.

One of the nano-materials of particular interest is nano-silica. In an abstract in the Journal of Dispersion Science and Technology, Vol. 25, No. 6/2004 at pp. 837 to 848, the grafting of nano-silica particles with a specific modification agent was reported. In another article entitled “HLDPE/Organic Functionalized SiO₂ Nanocomposites With Improved Thermal Stability And Mechanical Properties” it is reported that addition of pre-treating nano-silica with organic multifunctional modifiers lead to an increase of thermal stability, elastic modulus and toughness.

Accordingly, it is a specific object of the present invention to incorporate the beneficial properties of nano-mineral particles in finishes for yarns and fabrics of mineral and carbon fibers.

The invention will be better understood by reference to the Summary of the Invention and Detailed Description which follow.

### SUMMARY OF THE INVENTION

It has been surprisingly discovered that a unique and useful finish for mineral fibers and carbon fibers and fabrics can be achieved with the incorporation of nano-materials in the finishing composition. Thus, in one aspect the present invention is a composition for use in finishing mineral and carbon fibers comprising a coupling agent with nano-mineral particles grafted with the molecules of the coupling agent to form a finish composition whereby upon application of the composition to a mineral or carbon fiber surface the nano-polymers graft onto the fiber surface and form a three-dimensional matrix of the coupling agent. The coupling agent is preferably a silane copolymer coupling agent and may include a cross-linking agent. The mineral fiber may preferably be selected from the group consisting of fiberglass, S and S₂ fiberglass and quartz fibers.

In another aspect, the present invention is a process for finishing mineral and carbon fibers and fabrics comprising the steps of scouring the fabric to remove processing aids and any surface contaminants, applying a composition of silane copolymer coupling agent with nano-mineral particles grafted to the silane to the scoured fabric surface to graft to same; and applying a selected polymer to the grafted surface thereby finishing the fabric for its intended use.

### DETAILED DESCRIPTION

In a preferred process, a fabric of woven fibers of S glass or carbon is scoured to remove any processing aids or debris that may have attached to the fiber drawing the spinning and weaving process.

After the fabric has been cleaned and scoured it is then dipped, sprayed or rolled into a bath containing a cross-linked finish of a silane copolymer coupling agent with nano-mineral particles grafted to silane copolymer molecules therein. The cross-linking agents are selected according to the end product resin but all the silanes have the same chemistry to bond to an inorganic surface, that is, the siloxane group and other coupling group are available for cross-linking with the resin. The nano-minerals may be obtained from supplies such as Cabosil, BASF, Nyacol, and Snowtex and their concentration preferably is in the range from 0.1% to 20% by weight.

After removing the fabric from the bath, squeezing and removing any excess coupling agent, the treated glass fabric is ready to receive a final coating in a bath comprising polymeric material. Preferred coating polymers are epoxies, polyimides, and polyamides. The polymer pickup from the coating bath is preferably in the range from 0.01% to 20% by weight.

The resulting fabric will have improved structural strength and is suitable for ballistic protection and other application requiring high impact resistance.

In one preferred example which is a best present mode, samples of woven carbon fabric were scoured to remove any processing aids and were finished with finish 7899 of JPS Composite Materials, Inc. which contained nano-silica particles. After drying the fabric was treated in a bath comprising an epoxy and an epoxy cross-linking agent to coat the fabric. The resulting fabric has improved structural and ballistic properties.

It is understood that various and additional embodiments within the scope of this invention may occur to those skilled in the art after reading the above specification but the invention is limited only by the claims which follow:

We claim:

1. A composition for use in finishing mineral and carbon fibers and fabrics comprising:
a). a coupling agent; and
b). nano-mineral particles dispersed within said coupling agent and grafted to molecules of the coupling agent to form a finish composition whereby upon application of the composition to a mineral or carbon fiber surface the nano-mineral particles graft onto the fiber or fabric surface and form a three-dimensional matrix of the coupling agent.

2. The composition of claim 1 wherein the coupling agent is a silane copolymer coupling agent.

3. The composition of claim 2 including a cross-linking agent.

4. The composition of claim 1 wherein the mineral fiber is selected from the group consisting of glass and quartz fibers.

5. A process for finishing mineral and carbon fibers and fabrics comprising the steps of:
a) scouring the fabric to remove any processing aids and impurities on the surface thereof;
b) applying a composition of a silane coupling agent having nano-mineral particles grafted to silane copolymer molecules therein to the scoured fabric to treat same; and
c) applying a polymeric coating to said treated fabric.

6. The process of claim 5 wherein the fabric is a fiberglass fabric and the polymer is an epoxy.

7. The product of the process of claim 5.
